(19) United States
(12) Patent Application Publication
(10) Pub. No.: US 2010/0049414 A1
(43) Pub. Date: Feb. 25, 2010

(54) CONTROL APPARATUS FOR ELECTRIC VEHICLE

(75) Inventors: Yosuke Ohtomo, Tokyo (JP); Itaru Seta, Tokyo (JP)

Correspondence Address: DARBY & DARBY P.C., P.O. BOX 770, Church Street Station, New York, NY, 10008-0770, US

(73) Assignee: Fuji Jukogyo Kabushiki Kaisha, Tokyo (JP)

(21) Appl. No.: 12/506,407

(22) Filed: Jul. 21, 2009

(30) Foreign Application Priority Data
Aug. 22, 2008 (JP) 2008-213791
Mar. 25, 2009 (JP) 2009-073218

(51) Int. Cl. H02P 7/00; G06F 19/00

(52) U.S. Cl. 701/70; 318/452

(57) ABSTRACT

The present invention provides a control apparatus for an electric vehicle which improves safety in an electric vehicle capable of traveling using creep torque. The electric vehicle includes a motor/generator for driving vehicle wheels. In a low vehicle speed region during startup or the like, creep torque is output from the motor/generator even when an accelerator pedal has not been operated, and therefore the electric vehicle can be started gently. The electric vehicle is also provided with a friction brake system for applying vehicle braking through frictional force. When an EV control unit for setting a target creep torque of the motor/generator determines that an abnormality has occurred in the friction brake system (step S20), the target creep torque is set lower than normal (step S30). Therefore, when an abnormality that may cause a reduction in a braking force occurs in the friction brake system, a propulsive force of the electric vehicle can be reduced, and as a result, the safety of the electric vehicle can be improved.

### CROSS-REFERENCE TO RELATED APPLICATIONS

The disclosure of Japanese Patent Application No. 2008-213791 filed on Aug. 22, 2008 and Japanese Patent Application No. 2009-073218 filed on Mar. 25, 2009 including the specification, drawings, and abstract are incorporated herein by reference in its entirely.

### BACKGROUND OF THE INVENTION

1. Field of the Invention

The present invention relates to a control apparatus for an electric vehicle including an electric motor for driving vehicle wheels.

2. Description of the Related Art

An electric vehicle in which creep torque is generated by an electric motor has been proposed as an electric vehicle including an electric motor for driving vehicle wheels (see Japanese Unexamined Patent Application No. H9-37415 and Japanese Unexamined Patent Application No. H11-8907, for example). When creep torque is generated by the electric motor, the creep torque can be used to start the vehicle, similarly to a conventional vehicle having an engine and an automatic transmission, thereby an unpleasant sensation experienced by a driver who is accustomed to driving a conventional vehicle can be eliminated.

Further, by providing the electric motor for driving the vehicle wheels and causing the electric motor to generate power, braking can be applied to the vehicle while recovering energy. However, during regenerative braking by the electric motor, a braking force is affected by an output characteristic and a residual capacity of a battery, and it is therefore difficult to generate a large braking force with stability. Under such circumstances, an electric vehicle having a regenerative brake is also provided with a disc type or drum type friction brake.

Incidentally, the magnitude of the creep torque output by the electric motor is set on the basis of a vehicle speed, an accelerator operation, a brake operation, and so on. Depending on the vehicle condition, however, it is not always desirable to control the creep torque on the basis of only the vehicle speed and so on. For example, when an abnormality such as a pressure reduction occurs in a hydraulic system of the friction brake, the braking force generated by the friction brake may decrease. In case that the creep torque is set on the basis of only the vehicle speed and the vehicle is caused to creep forward in circumstances where the braking force may decrease, the number of times braking must be applied to the vehicle increases, which is undesirable.

### SUMMARY OF THE INVENTION

An object of the present invention is to improve safety in an electric vehicle having an electric motor that outputs creep torque.

A control apparatus for an electric vehicle according to the present invention is a control apparatus for an electric vehicle having an electric motor for driving vehicle wheels, including: torque setting means for setting a target creep torque of the electric motor on the basis of a vehicle condition; motor control means for drive-controlling the electric motor on the basis of the target creep torque; brake abnormality detecting means for detecting an abnormality in a brake system for applying vehicle braking; and torque reducing means for lowering the target creep torque when an abnormality occurs in the brake system.

The control apparatus for an electric vehicle according to the present invention further includes weight estimating means for estimating a vehicle weight, wherein the torque reducing means lowers the target creep torque by a steadily larger amount as the estimated vehicle weight increases.

The control apparatus for an electric vehicle according to the present invention further includes information means for informing a passenger of the abnormality in the brake system.

According to the present invention, the target creep torque is lowered when an abnormality occurs in the brake system, and therefore, in circumstances where a braking force may decrease, a driving force of the electric vehicle can be lowered, enabling an improvement in the safety of the electric vehicle.

### BRIEF DESCRIPTION OF THE DRAWINGS

FIG. 1 is a schematic diagram showing the constitution of an electric vehicle to which a control apparatus for an electric vehicle according to an embodiment of the present invention is applied;

FIG. 2 is a block diagram showing a control system for setting a target creep torque;

FIG. 3 is a characteristic line diagram that is referred to when setting the target creep torque;

FIG. 4 is a flowchart showing an example of a target creep torque lowering procedure;

FIG. 5 is a characteristic line diagram that is referred to when lowering the target creep torque;

FIG. 6 is a block diagram showing a control system for setting the target creep torque;

FIG. 7 is a flowchart showing an example of a target creep torque lowering procedure;

FIG. 8 is a characteristic line diagram that is referred to when lowering the target creep torque; and

FIG. 9 is a schematic diagram showing the constitution of an electric vehicle including an electric parking brake.

### DESCRIPTION OF THE PREFERRED EMBODIMENTS

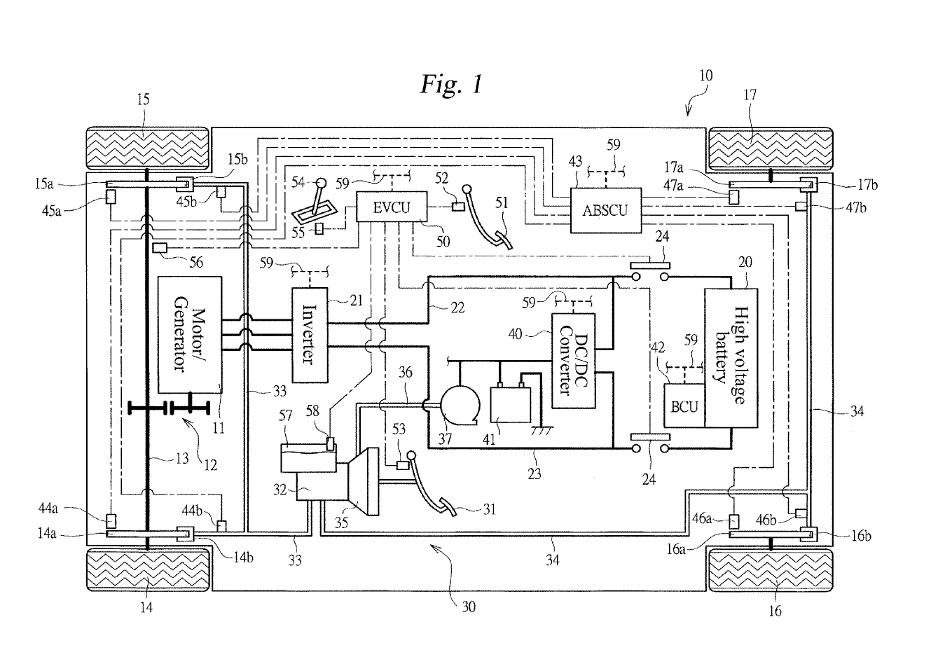

An embodiment of the present invention will be described in detail below on the basis of the drawings. FIG. 1 is a schematic diagram showing the constitution of an electric vehicle 10 to which a control apparatus for an electric vehicle 10 according to an embodiment of the present invention is applied. As shown in FIG. 1, a motor/generator (electric motor) 11 for driving vehicle wheels is installed in the electric vehicle 10. A drive shaft 13 is connected to the motor/generator 11 via a gear train 12, and vehicle wheels 14, 15 are connected to the drive shaft 13. Further, a high voltage battery 20 for supplying power to the motor/generator 11 and storing power generated by the motor/generator 11 is installed in the electric vehicle 10. A 400 V lithium ion rechargeable battery, for example, is used as the high voltage battery 20.

Further, an inverter 21 is connected to the motor/generator 11, and the inverter 21 is connected to the high voltage battery 20 via current carrying cables 22, 23. When the motor/generator 11 is driven as a motor, a direct current from the high voltage battery 20 is converted into an alternating current by the inverter 21, whereupon the converted alternating current is supplied to the motor/generator 11. When the motor/generator 11 is driven as a generator, on the other hand, an alternating current from the motor/generator 11 is converted into a direct current by the inverter 21, whereupon the converted direct current is supplied to the high voltage battery 20. Furthermore, by controlling a current value and a frequency of the alternating current using the inverter 21, a torque and a rotation speed of the motor/generator 11 can be controlled. Note that a main relay 24 is provided on the current carrying cables 22, 23 for guiding the direct current from the high voltage battery 20.

As noted above, by driving the motor/generator 11 as a generator, regenerative braking can be applied to the electric vehicle 10. However, a friction brake system (brake system) 30 for applying braking to vehicle wheels 14 to 17 is provided in the illustrated electric vehicle 10. The friction brake system 30 includes a master cylinder 32 for generating oil pressure in accordance with depression of a brake pedal 31 by a driver, and calipers 14b to 17b for applying braking to disc rotors 14a to 17a of the respective vehicle wheels 14 to 17 through frictional force. The calipers 14b to 17b are respectively connected to the master cylinder 32 via brake pipes 33, 34, and the calipers 14b to 17b can be activated by oil pressure supplied through the brake pipes 33, 34. Furthermore, a vacuum booster 35 is attached to the master cylinder 32, and a pedal force increased via the vacuum booster 35 is transmitted to the master cylinder 32. Moreover, an electric negative pressure pump 37 is connected to the vacuum booster 35 via a negative pressure pipe 36.

Further, a low voltage battery 41 is connected to the high voltage battery 20 via a DC/DC converter 40. A 12 V lead storage battery, for example, is used as the low voltage battery 41. The low voltage battery 41 functions as a power supply for the inverter 21, the converter 40, and various control units 42, 43, 50 to be described below, and as a power supply for the electric negative pressure pump 37, headlights, tail lamps, and so on. Moreover, a low voltage current is generated from a high voltage current by the converter 40, and therefore power can be supplied to the low voltage battery 41 from the high voltage battery 20.

A battery control-unit (BCU) 42 is provided in the electric vehicle 10 to control charging/discharging of the high voltage battery 20. The battery control unit 42 is capable of calculating a state of charge (SOC), which represents the residual capacity of the high voltage battery 20, on the basis of the voltage, current, temperature, and so on of the high voltage battery 20 detected by various sensors not shown in the drawings. The electric vehicle 10 is further provided with a brake control unit (ABSCU) 43 for controlling the activation state of the friction brake system 30. To detect the activation state of the friction brake system 30, vehicle wheel speed sensors 44a to 47a for detecting vehicle wheel speeds are provided respectively on the vehicle wheels 14 to 17 and oil pressure sensors 44b to 47b for detecting oil pressures are provided on the brake pipes 33, 34. The brake control unit 43 controls the calipers 14b to 17b by regulating an electromagnetic valve and a hydraulic pump, not shown in the drawings, on the basis of vehicle wheel speed data from the vehicle wheel speed sensors 44a to 47a and oil pressure data from the oil pressure sensors 44b to 47b, thereby ensuring that the vehicle wheels 14 to 17 do not lock during vehicle braking.

The electric vehicle 10 is also provided with an EV control unit (EVCU) 50 for performing overall control of the vehicle conditions of the electric vehicle 10. An accelerator pedal sensor 52 for detecting an operating condition of an accelerator pedal 51, a brake pedal sensor 53 for detecting an operating condition of the brake pedal 31, a range switch 55 for detecting an operating position of a select lever 54, a vehicle speed sensor 56 for detecting a vehicle speed, and so on are connected to the EV control unit 50. Various signals representing vehicle conditions such as the state of charge, an accelerator operating amount, a brake operating amount, the vehicle speed, and a range position are input into the EV control unit 50. On the basis of these detection signals, the EV control unit 50 sets a target torque and a target rotation speed of the motor/generator 11 and executes drive control on the motor/generator 11 by outputting a control signal to the inverter 21. Further, an oil level sensor 58 for detecting a brake fluid level is provided in a tank 57 of the master cylinder 32, and oil level data from the oil level sensor 58 are input into the EV control unit 50. Note that the EV control unit 50, battery control unit 42, brake control unit 43, inverter 21, converter 40, and so on are connected to each other via a communication network 59.

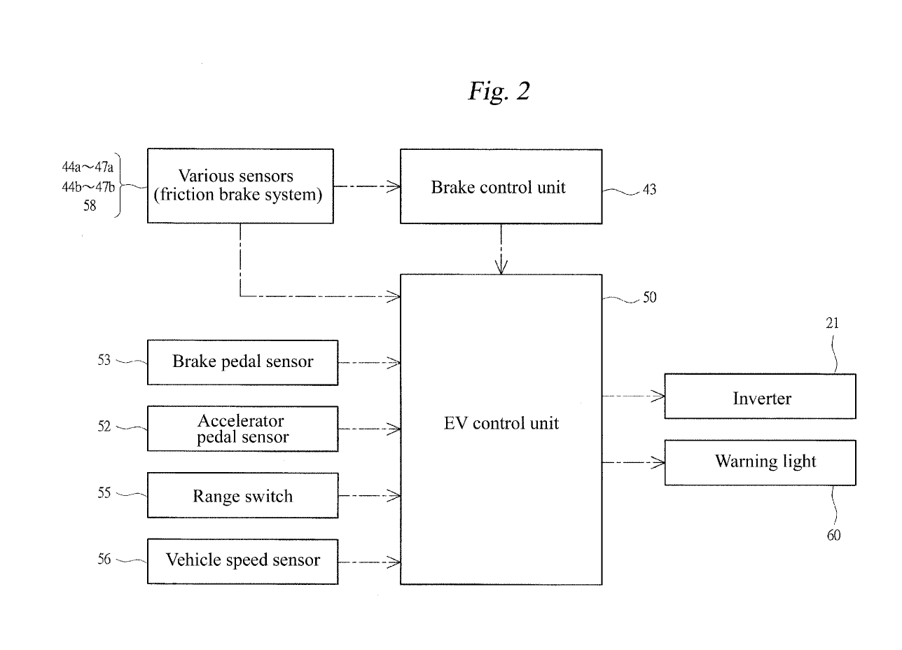

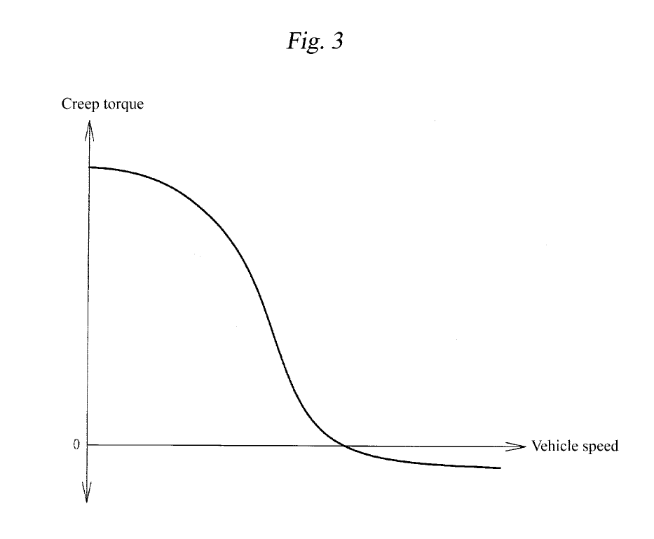

Next, creep control for generating creep torque from the motor/generator 11 will be described. Here, FIG. 2 is a block diagram showing a control system for setting a target creep torque, and FIG. 3 is a characteristic line diagram that is referred to when setting the target creep torque. As shown in FIG. 2, the EV control unit 50 functioning as torque setting means and motor control means sets the target creep torque on the basis of the vehicle conditions, and outputs a control signal corresponding to the target creep torque to the inverter 21. On the basis of a detection signal from the range switch 55, the EV control-unit 50 determines whether or not the range position corresponds to a travel range. Further, on the basis of a detection signal from the accelerator pedal sensor 52, the EV control unit 50 determines whether or not the accelerator pedal 51 is depressed. When the travel range has been selected and the accelerator pedal 51 is not depressed, the EV control unit 50 sets a target creep torque corresponding to the vehicle speed by referring to the characteristic line diagram shown in FIG. 3. Hence, when the accelerator pedal 51 is not depressed in a low vehicle speed region during startup or the like, the electric vehicle 10 can be started gently by the creep torque, enabling an improvement in user-friendliness. Note that the aforementioned travel range includes a drive range (D range), a reverse range (R range), and so on, which are selected during travel.

Incidentally, the creep torque that is output from the motor/generator 11 acts in a direction for accelerating the electric vehicle 10, and therefore, if an abnormality occurs in the friction brake system 30 for applying braking to the electric vehicle 10, it becomes important to control the creep torque appropriately to ensure safety. Hence, when an abnormality is detected in the friction brake system 30, the EV control unit 50 lowers the target creep torque.

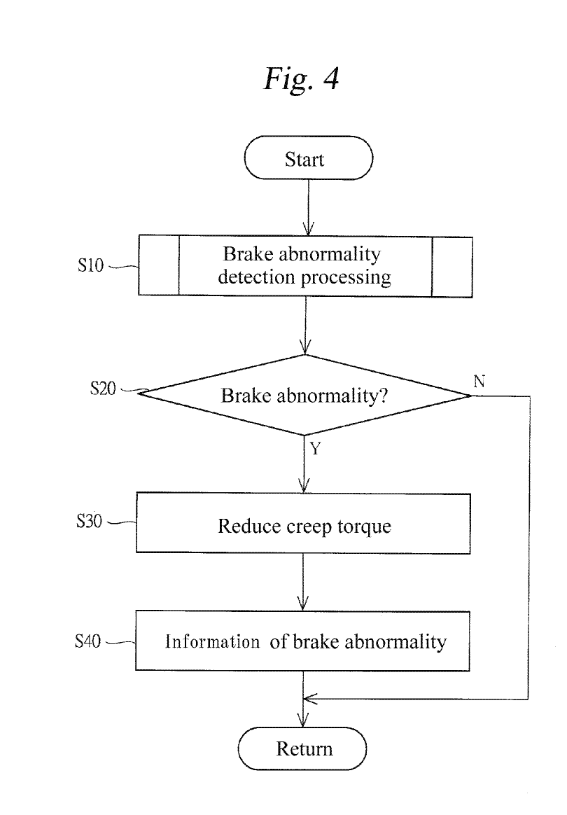

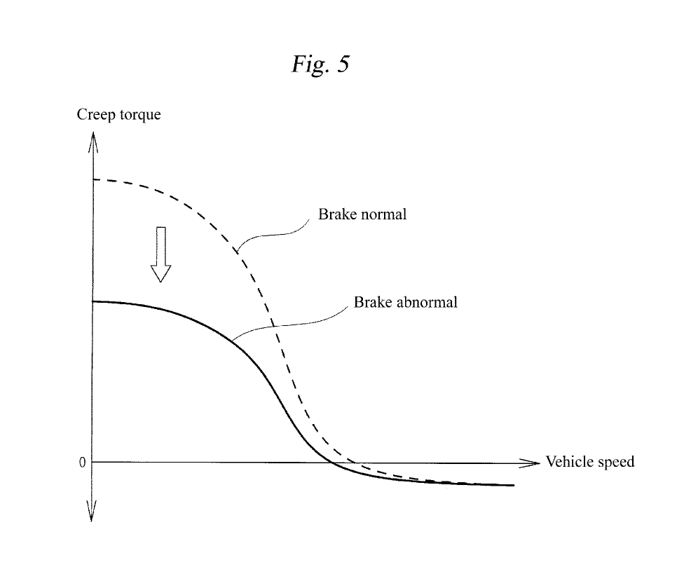

FIG. 4 is a flowchart showing an example of a target creep torque lowering procedure, and FIG. 5 is a characteristic line diagram that is referred to when lowering the target creep torque. As shown in FIG. 4, in a step S10, brake abnormality detection processing is executed to detect an abnormality in the friction brake system 30. In the brake abnormality detection processing, variation exceeding a predetermined range in relation to the vehicle wheel speed data from the respective vehicle wheel speed sensors 44a to 47a, an abnormal value in the oil pressure data from the oil pressure sensors 44b to 47b, an abnormal value in the oil level data from the oil level sensor 58, a communication abnormality in relation to the brake control unit 43, an activation abnormality in relation to the electric negative pressure pump 37, and so on are detected.

Next, in a step S20, the EV control unit 50 serving as brake abnormality detecting means determines whether or not an abnormality has occurred in the friction brake system 30 on the basis of the various detection results obtained in the brake abnormality detection processing. When it is determined in the step S20 that an abnormality has not occurred in the friction brake system 30, the target creep torque is maintained and the routine is terminated. On the other hand, when it is determined in the step S20 that an abnormality has occurred in the friction brake system 30, the routine advances to a step S30, in which the EV control unit 50 serving as torque reducing means lowers the target creep torque in accordance with the characteristic line diagram shown in FIG. 5. In a step S40, a passenger is notified of the abnormality in the friction brake system 30 via a warning light 60 or the like serving as information means. Note that by employing a speaker as the information means instead of the warning light 60, which is incorporated into an instrument panel or the like as the information means, the passenger can be informed of the abnormality in the friction brake system 30 via a warning sound or the like.

Hence, when an abnormality occurs in the friction brake system 30, the target creep torque is lowered, and therefore acceleration of the electric vehicle 10 can be suppressed. As a result, the number of times vehicle braking must be applied using the friction brake system 30 can be reduced, enabling an improvement in the safety of the electric vehicle 10. Furthermore, the passenger is notified of the abnormality in the friction brake system 30, and therefore the passenger can be encouraged to take appropriate measures, enabling a further improvement in the safety of the electric vehicle 10. Note that in the above description, the target creep torque is reduced by referring to the characteristic line diagram shown in FIG. 5 when an abnormality occurs in the friction brake system 30, but the present invention is not limited thereto, and the target creep torque may be reduced through calculation using a correction coefficient. Alternatively, the target creep torque may be lowered to zero when an abnormality occurs in the friction brake system 30. Furthermore, the amount by which the target creep torque is lowered may be varied in accordance with the content of the abnormality in the friction brake system 30.

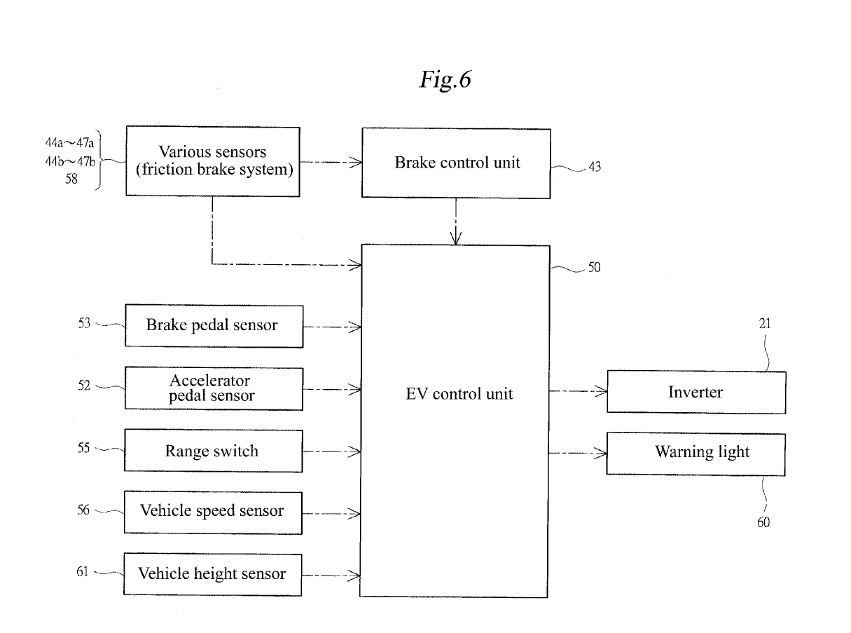

Next, a control apparatus according to another embodiment of the present invention will be described. FIG. 6 is a block diagram showing a control system for setting the target creep torque. Identical constitutions to the constitutions shown in FIG. 2 have been allocated identical reference symbols, and description thereof has been omitted. As shown in FIG. 6, a vehicle height sensor 61 is connected to the EV control unit 50, and vehicle height data from the vehicle height sensor 61 are input into the EV control unit 50. The vehicle height sensor 61 is provided on a suspension, not shown in the drawing, of the electric vehicle 10, and is capable of detecting vehicle height variation accompanying increases and decreases in a carried weight. On the basis of the vehicle height data from the vehicle height sensor 61, the EV control unit 50 functioning as weight estimating means estimates the weight (vehicle weight) of the electric vehicle 10. Note that during estimation of the vehicle weight, vehicle height data obtained when the electric vehicle 10 is in a rest state are preferably used. Further, instead of estimating the vehicle weight using only the vehicle height data, the vehicle weight may be estimated taking into account the number of passengers, which is estimated from a seatbelt use condition and a seating condition.

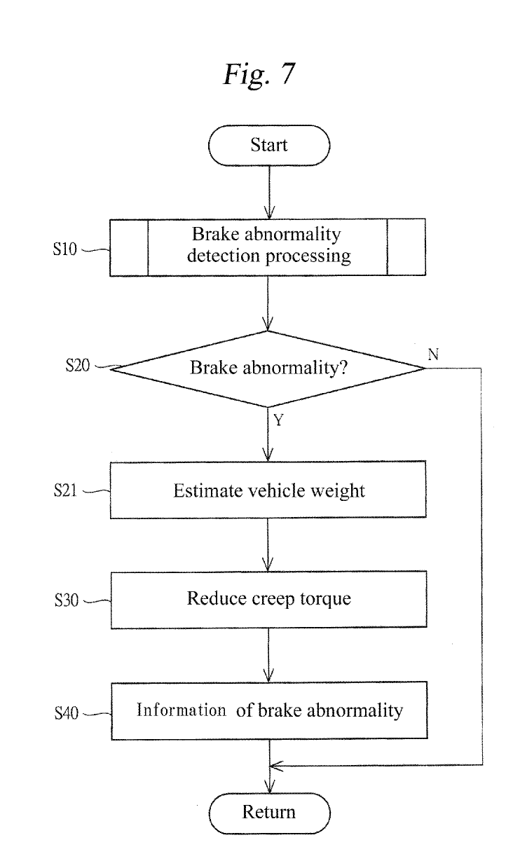

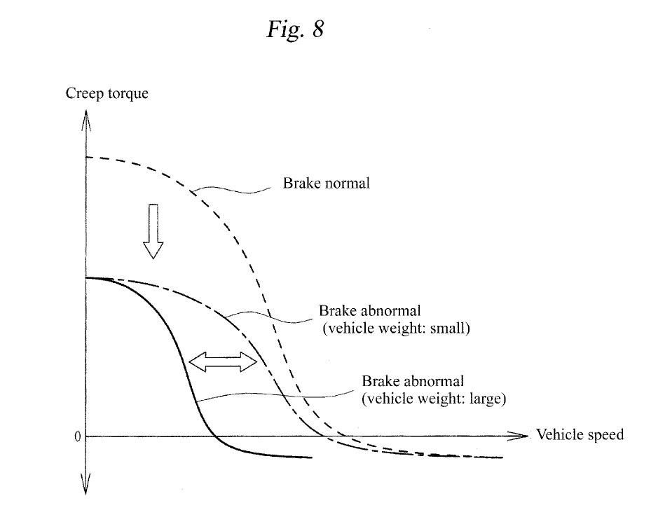

Next, a target creep torque lowering procedure performed when an abnormality occurs in the friction brake system 30 will be described. Here, FIG. 7 is a flowchart showing an example of the target creep torque lowering procedure. Identical steps to the steps shown in FIG. 4 have been allocated identical step numbers, and description thereof has been omitted. Further, FIG. 8 is a characteristic line diagram that is referred to when lowering the target creep torque. As shown in FIG. 7, in a step S10, the brake abnormality detection processing is executed, and in a step S20, a determination is made as to whether or not an abnormality has occurred in the friction brake system 30. When it is determined in the step S20 that an abnormality has not occurred in the friction brake system 30, the target creep torque is maintained and the routine is terminated. On the other hand, when it is determined in the step S20 that an abnormality has occurred in the friction brake system 30, the routine advances to a step S21, in which the vehicle weight of the electric vehicle 10 is estimated. Next, in a step S30, the target creep torque is lowered on the basis of the estimated vehicle weight and in accordance with the characteristic line diagram shown in FIG. 8. In a step S40, the passenger is informed of the abnormality in the friction brake system 30 via the warning light 60 or the like.

As shown in FIG. 8, when the vehicle weight is estimated to be large (heavy), the target creep torque is reduced greatly, and when the vehicle weight is estimated to be small (light), the target creep torque is reduced slightly. By varying the amount by which the target creep torque is lowered in accordance with the vehicle weight in this manner, the target creep torque can be set appropriately, taking into account an inertial force acting on the electric vehicle 10. Hence, when the vehicle weight is large, leading to an increase in a load applied to the friction brake system 30, the load applied to the friction brake system 30 can be reduced by lowering the target creep torque greatly, and as a result, an improvement in the safety of the electric vehicle 10 can be achieved. Note that FIG. 8 shows two characteristic lines that are referred to separately in accordance with the magnitude of the vehicle weight, but the amount by which the target creep torque is lowered may be varied in a stepped fashion or continuously in accordance with the vehicle weight.

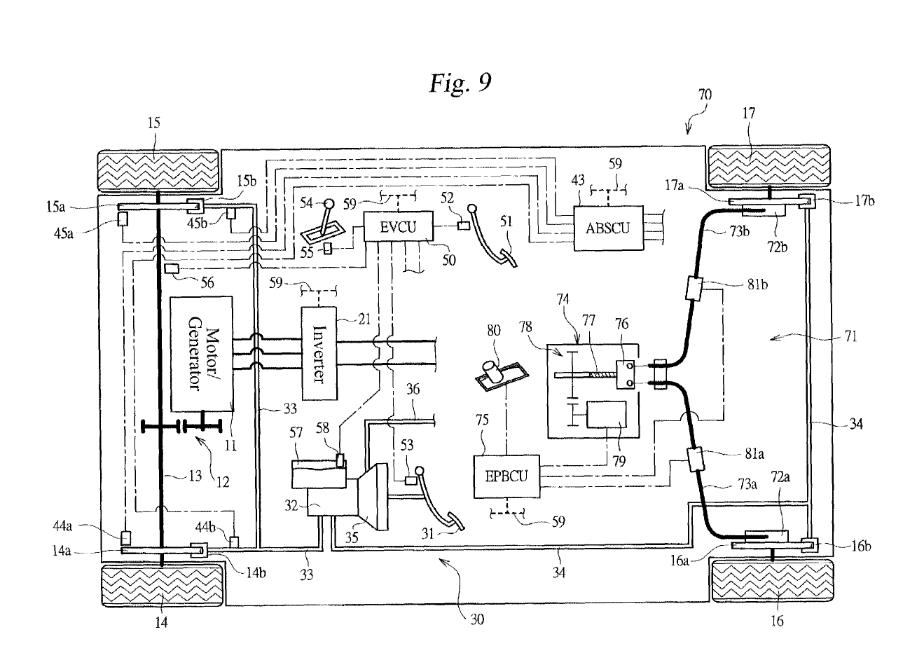

Further, in the above description, the target creep torque is lowered when an abnormality is detected in the friction brake system 30, but the present invention is not limited thereto, and the target creep torque may be lowered when an abnormality is detected in an electric parking brake 71 used when the vehicle is parked, for example. Here, FIG. 9 is a schematic diagram showing the constitution of an electric vehicle 70 having the electric parking brake 71. Note that the constitution of the electric vehicle 70 shown in FIG. 9 is obtained by adding the electric parking brake 71 to the electric vehicle 10 described above. Furthermore, in FIG. 9, identical members to the members shown in FIG. 1 have been allocated identical reference symbols, and description thereof has been omitted.

As shown in FIG. 9, the electric parking brake 71 installed in the electric vehicle 70 includes brake units 72a, 72b provided on the vehicle wheels 16, 17. Each brake unit 72a, 72b is incorporated into a wheel hub portion, not shown in the drawing, positioned on an inner diameter side of the disc rotor 16a, 17a. The brake unit 72a, 72b is constituted by a brake drum, not shown in the drawing, connected to the vehicle wheel 16, 17, and a brake shoe, not shown in the drawing, housed in the brake drum. Further, rear cables 73a, 73b for controlling a pressing state of the brake shoe relative to the brake drum are connected to the respective brake units 72a, 72b. By tautening the rear cables 73a, 73b, the brake units 72a, 72b are switched to a braking state for applying braking to the vehicle wheels 16, 17, and by relaxing the rear cables 73a, 73b, the brake units 72a, 72b are switched to a released state in which braking is not applied to the vehicle wheels 16, 17. Note that the rear cables 73a, 73b possess flexibility, and the refore deform in accordance with a stroke of a rear suspension, not shown in the drawing.

Further, an electric actuator 74 is provided in the electric vehicle 70 to operate the rear cables 73a, 73b, and the electric actuator 74 is drive-controlled by an electrically parking brake control unit (EPBCU) 75. Furthermore, the electric actuator 74 includes an equalizer 76 to which respective end portions of the left and right rear cables 73a, 73b are connected, and a lead screw 77 screwed to the equalizer 76. The electric actuator 74 is further provided with a DC motor 79 for driving the lead screw 77 to rotate via a reduction gear train 78. The parking brake control-unit 75 controls the driving state of the DC motor 79 in accordance with the operating condition of a brake operation switch 80 operated by the passenger, and as a result, the rear cables 73a, 73b are tautened and relaxed via the lead screw 77 and the equalizer 76. Moreover, tension sensors 81a, 81b for detecting a cable tension are incorporated into the rear cables 73a, 73b, respectively.

In the electric vehicle 70 installed with the electric parking brake 71 described above, the EV control unit 50 functioning as the brake abnormality detecting means determines whether or not an abnormality has occurred in the electric parking brake 71. The operating condition of the brake operating switch 80, an activation position of the equalizer 76, the cable tension of the rear cables 73a, 73b, and so on are input into the EV control unit 50 from the parking brake control unit 75, and on the basis of this information, the EV control unit 50 determines whether or not an abnormality has occurred in the electric parking brake 71. For example, when the rear cables 73a, 73b have been tautened by the electric actuator 74 to activate the electric parking brake 71 but the cable tension detected by the tension sensors 81a, 81b is lower than a predetermined value or the like, an abnormality is determined to have occurred in the electric parking brake 71, and therefore the target creep torque is lowered as described above. When the target creep torque is lowered upon the occurrence of an abnormality in the electric parking brake 71, similar effects to the effects described above can be obtained.

The present invention is not limited to the embodiments described above, and may be subjected to various modifications within a scope that does not depart from the spirit thereof. For example, in the illustrated example, the present invention is applied to the electric vehicle 10 having only the motor/generator 11 as a power source. However, the present invention is not limited thereto, and may also be applied to a hybrid type electric vehicle having the motor/generator 11 and an engine as power sources. Furthermore, in the above description, the target creep torque is set in accordance with the vehicle speed, but the target creep torque may be varied in accordance with the brake operating amount.

What is claimed is:

1. A control apparatus for an electric vehicle having an electric motor for driving vehicle wheels, comprising:
torque setting means for setting a target creep torque of said electric motor on the basis of a vehicle condition;
motor control means for drive-controlling said electric motor on the basis of said target creep torque;
brake abnormality detecting means for detecting an abnormality in a brake system for applying vehicle braking; and
torque reducing means for lowering said target creep torque when said abnormality occurs in said brake system.

2. The control apparatus for an electric vehicle according to claim 1, further comprising weight estimating means for estimating a vehicle weight,
wherein said torque reducing means lowers said target creep torque by a steadily larger amount as said estimated vehicle weight increases.

3. The control apparatus for an electric vehicle according to claim 1, further comprising information means for informing a passenger of said abnormality in said brake system.
